(19) United States
(12) Patent Application Publication
(10) Pub. No.: US 2005/0249459 A1
(43) Pub. Date: Nov. 10, 2005

(54) Optical ferrule connector

(76) Inventors: Bogdan Rosinski, Brest (FR); Gnitaboure Yabre, Le Mans (FR)

Correspondence Address: HARRINGTON & SMITH, LLP, 4 RESEARCH DRIVE, SHELTON, CT, 06484-6212, US

(21) Appl. No.: 10/505,303

(22) PCT Filed: Feb. 19, 2003
(86) PCT No.: PCT/EP03/50024

§ 371 Date: Apr. 4, 2005

(30) Foreign Application Priority Data
Feb. 21, 2002 (FR) 02/02250

(51) Int. Cl. G02B 6/32

(52) U.S. Cl. 385/33

(57) ABSTRACT

To simplify the making of a connector of optical ferrules for interconnecting two optical fibers in particular of different types, an adapting space made of a material transparent to light rays is provided. A plate physically representing said space bears, on either side, two convergent lenses. Such an arrangement provides many degrees of freedom to adjust the characteristics of the transmission of light rays from one optical fiber to another optical fiber.

### BACKGROUND OF THE INVENTION

1. Field of the Invention

An object of the present invention is an optical ferrule connector chiefly used in the field of transmission by optical fibers. The aim of the invention is both to simplify the interconnection of optical fibers with one another, and also the interconnection of optical fibers with optoelectronic transmitters or receivers, and to augment the performance of this connection especially in terms of transmitted power as well as of adaptation of transmission modes.

An optical fiber is used essentially as a means to convey information in the form of light signals that are normally digitized. This means of transportation has the advantage of efficiently resisting noise, especially electromagnetic noise, and furthermore enabling very high data bit rates. However, since processing in present-day computer devices is of the electronic type, it is important to carry out an optoelectronic conversion of the light signals to be processed at input and output of the optical fiber. Various solutions have been devised for these problems of conversion.

2. Description of the Prior Art

Certain solutions have entailed the idea of making harnesses. In these harnesses, an optical fiber or a bundle of optical fibers is provided, fixedly at both its ends (or at least at one of its ends), with an optoelectronic conversion device. The drawback of this type of solution is that the ease with which the fiber can be handled is thereby greatly reduced. Indeed, it will easily be understood that the length of the fiber cannot be adjusted as easily as desired, especially if it is provided on either side with electronic conversion circuits crimped to the ends of the fibers. In this case, it is not at all possible to lengthen or shorten the fiber. All that can be done is to exchange it for another differently sized harness, which however will also be a high-cost harness. Besides, the presence of the electronic conversion circuit leads to the making of a joining piece at the end of the optical fiber. The bulkiness of this joining piece is inconvenient if the fiber has to be threaded into narrow holes to conduct the signals from one place to another.

In other approaches, especially the document WO 00/55665, an intermediate ferrule has been devised. This ferrule is, on the one hand, designed to enable optical connection and is, on the other hand, provided with integrated optoelectronic conversion means. However, owing to the chosen technique of transmission and the mechanical architecture used to make the device, an optical reflection mirror has to be prepared between the exit from the optical fibers and an optoelectronic detector or emitter responsible for making the conversion.

Independently of the mirrors, another problem arises, namely that of the adaptation of the transmission modes and more generally that of the performance of the interconnection between two fibers. More simply, it can be said that, from the viewpoint of transmission performance, transmission by single-mode fiber is of greater utility than transmission by multimode fiber. Indeed, in a multimode fiber, the fact that several propagation modes exist at the same time leads to high dispersion, which is detrimental to the transmission of certain spectral components, especially at high frequencies. The result of this is that the binary signals, with sharp transitions, transmitted on the optical fibers, are transmitted with less sharp and slower transitions. Consequently, the useful bit rate of the optical fiber is reduced. However, the multimode fibers have a wider transmission core, substantially in the range of 60 micrometers. They are therefore far easier to manufacture on an industrial scale than single-mode fibers with thinner cores typically in the range of 10 micrometers. Consequently, single-mode fibers are used for long-distance links while multimode servers are used for short-distance links.

In practice, it is therefore necessary to have interconnection devices available to interconnect these fibers. Hence, especially as presented in the document U.S. Pat. No. 5,168,537, for the link between an optoelectronic transmitter or receiver and an optical fiber termination, it is necessary to design an optical adapter. Such an adapter has especially a lens whose focal point is adjusted so as to correspond as closely as possible to the transmission or reception surfaces of fiber optical terminations or detection or transmission integrated circuits. However, owing to the complexity of such optical adapters, it is not possible to manufacture them at low cost.

It is an object of the invention to overcome these drawbacks by proposing an adapter that is capable in particular of being manufactured on an industrial scale at low cost. Furthermore, the invention makes use of means with far higher performance to organize the matching of optical interconnection so as to meet all requirements. The principle of the invention consists of the arrangement, in an interconnection space between two optical fiber terminations, or between a termination of an optical fiber and an optoelectronic integrated circuit, of two lenses themselves separated from each other by an adaptation space. It will be shown here below that by playing on the focal power of each of the lenses, the size of these lenses as well as the distance of the adaptation space, there are many more degrees of freedom available than in the prior art to obtain an adaptation of transmission. To obtain the best result, the method then works by simulation and by empirical approach in modifying these parameters to obtain the best result. The structure forming the adaptation space is a simple transparent plate (made of glass, plastic or even resin) against which the lenses are placed and in which the light propagation is unhampered. The manufacture is thereby greatly facilitated.

### SUMMARY OF THE INVENTION

An object of the invention therefore is a connector comprising ports to receive optical ferrules and to correspond to single-mode to multi-mode conversions and vice versa, comprising an input optical port and an output optical port, characterized in that it comprises a set of two lenses each with a flat face, interposed between the two optical ports and placed against a plate made of transparent material to enable an adaptation of transmission of the light rays in space and in energy density, the two lenses having respective diameters and radii of curvature that are different to form a fanning out of the beam of light rays, from narrow to wide or in the other direction, from one optical port to the other.

### BRIEF DESCRIPTION OF THE DRAWINGS

The invention will be understood more clearly from the following description and the accompanying figures. These figures are given purely by way of an indication and in no way restrict the scope of the invention. Of these figures:

FIG. 1 is a diagrammatic representation of an optical ferrule connector according to the invention;

FIG. 2 are graphs representing the values of power transmitted respectively in the prior art and with the improvement of the invention;

FIG. 3 is a diagrammatic representation of the significant increase in performance caused by the presence of the adapter of the invention;

FIGS. 4a and 4b show particular features of assembly of the optical ferrule connector according to the invention in interconnection between two fibers, especially fibers of different types, or respectively in interconnection of one fiber and of one optoelectronic transmission or reception circuit;

FIG. 5 shows an array structure enabling a simultaneous interconnection of several optical fibers presented side by side.

### MORE DETAILED DESCRIPTION

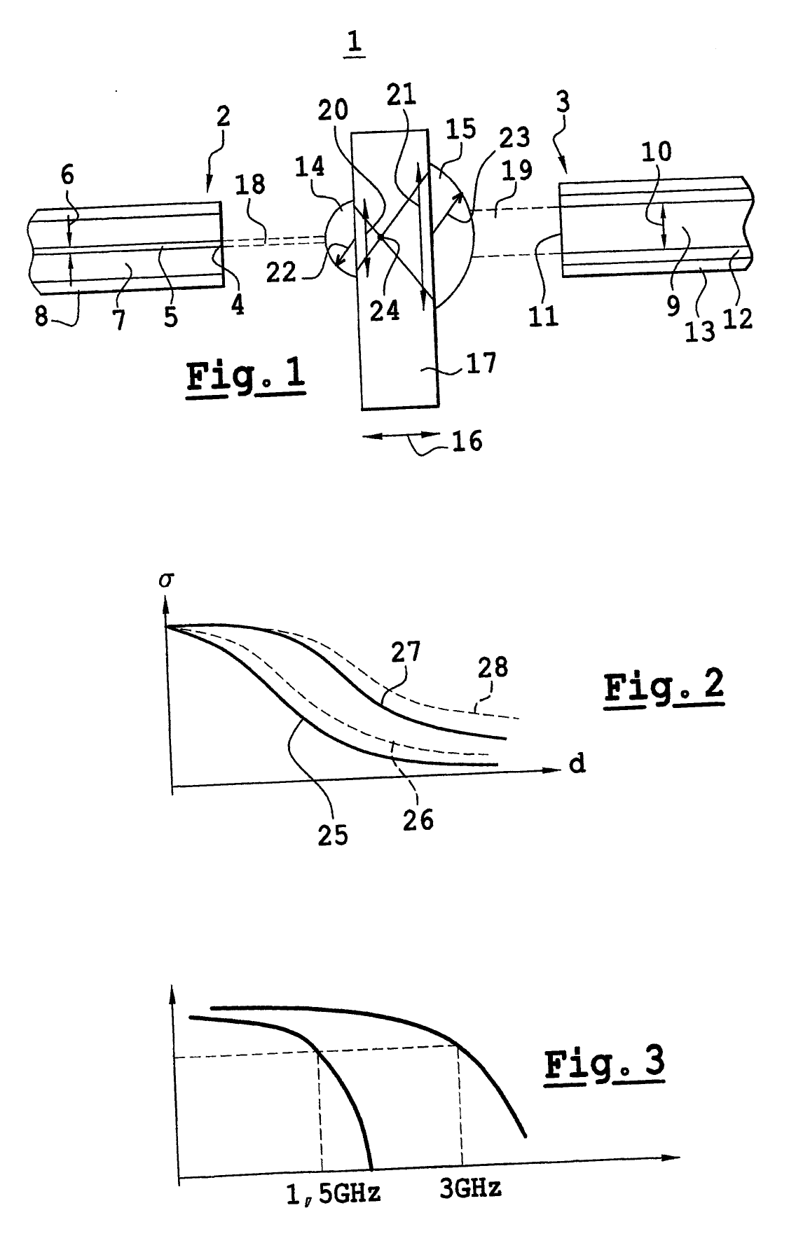

FIG. 1 is a diagrammatic view of an optical ferrule connector 1 according to the invention. This connector 1 has an input optical port 2, located here by way of an example to the left of the figure, and an output optical port 3 located to the right of the figure. The optical port 2 receives a termination 4 of an optical fiber 5, which here is a single-mode fiber and has a small core diameter 6 (for example 10 micrometers). The fiber 5, made of a material transparent to light, is surrounded by a sheath 7 made of a material with a lower refraction index, enabling the guidance of the light rays in the core 5 of the optical fiber. The assembly is protected by a solid ferrule 8. On the output port 3 side, a multimode optical fiber 9 with a far greater core diameter 10 (equal for example to 60 micrometers) has a termination 11 facing the termination 4. The fiber 9 also has a sheath 12 and a ferrule 13. The overall diameter of a section of the fiber 9 is in the same range as the overall diameter of the fiber 5.

The connector according to the invention has a set of two lenses 14 and 15, interposed between the two optical ports 2 and 3. The two lenses 14 and 15 are themselves separated from each other by an adaptation space 16. The term “lenses” 14 and 15, can equally well be understood to mean optical gratings and even holograms: the essential characteristic of the lenses 14 and 15 is that they have a convergent focusing capacity. At the practical level, the lenses 14 and 15 are made by the overmolding of a resin transparent to light radiation, overmolded on the transparent plate 17, which is preferably made of glass. In this solution, the lenses 14 and 15, may present preferably circular sections, with respective diameters 20 and 21 different from each other, to the rays 18 and 19 coming from or going to the optical terminations 4 and 11 respectively. For example, the diameter 20 is notably smaller than the diameter 21, and is equal for example to only half of this diameter 21.

Similarly these lenses, while they are made in the form of spherical or pseudo-spherical lenses, may have radii of curvature, 22 and 23 respectively, that are different from each other. In this way, parameters are available that can be used to modify the input and output pupils of the device, the focusing power values as well as the chosen mode of transmission.

The two lenses 14 and 15 are convergent lenses and their point of convergence will preferably be located in the adaptation space 16. It will be possible, however, for these points of convergence to be not located in this space. Besides, the point of convergence or focal point of each of the lenses could be common and be a point 24, located in the adaptation space 16. With the point of convergence 24, the rays are divergent after their convergence at this point.

The device works as follows. The radiation 18 coming from example from the single-mode fiber 4 (represented here in parallel form to simplify the explanation whereas it is not parallel in reality) is focused by the lens 14 on the point 24. From this point onwards 24, this radiation diverges and spreads in the transparent adaptation space 16 to fan out on an input face of the lens 15. To the extent that this lens 15 is also a convergent lens, it converts the divergent light radiation that strikes it into a parallel radiation 19. It can be noted that the parallel radiation 18 diagrammatically shown in the form of a thin beam coming from the small-diameter core 6 of the optical fiber 5 now fans out in the form of a wider beam well suited to penetrating the optical fiber 9 with a wider core diameter 10. Then, to perform the setting, there are many parameters or degrees of freedom available: these are the spread of the adaptation space 16 between the two lenses 14 and 15, as well as the diameters and the radii of curvature or more precisely the focal distances of these lenses.

FIG. 2 gives a view, in practice, of the technical effect of the invention. The y-axis measures the efficiency of coupling σ given as a function of the lateral shift d measured on the x-axis. What is done is to play on the light impact as well as the radius of curvature and the aperture of the beam. The aim is to minimize the power losses. The losses are injection losses, line losses, losses by detection and penalties related to high dispersion. The aim is to increase the potential transmission distance. Furthermore, the minimizing of the losses may enable the source to be polarized at a lower level to obtain better stabilization, better behavior under temperature and a longer life. In this way, this approach gives the result of increasing the alignment tolerance values without affecting the quality of transmission, and the performance is improved by selective excitation of the modes in the multimode fiber.

FIG. 2 thus shows that the coupling efficiency σ increases when passing from a one-lens assembly (curves 25 or 26) to an assembly with two lenses and an adaptation space (curves 27 and 28). The curves 25 and 27 relate to spherical lenses. The curves 26 and 28 relate to aspherical lenses for which the efficiency is even greater. FIG. 2 shows in particular that, as a function of a lateral shift (misalignment of the fibers), the coupling efficiency σ of the two-lens assembly of the invention is appreciably less affected.

In particular, the presence of these numerous degrees of freedom enables the choice of a power curve that is the one most appropriate for promoting an increase in the binary rate of transmission of the digital light signals with the fiber 9 over a long distance. For example FIG. 3 shows that, with a classic interconnection device of the prior art, the cut-off frequency at 3 decibels of the useful bit rate is located about 1.5 Gbit/s, whereas with the invention, a value of 3 Gbit/s is easily achieved, quite simply because the high spectral components of the transmitted binary light signals are better transmitted. Ultimately, it is the adaptability of the transmission curves 27, 28 that makes the interconnection device of the invention perform particularly well.

It can be noted that this adaptability is obtained by a system that is itself particularly simple: in one example, it consists of a glass plate on which two lenses made of transparent resin are overmolded. This device enables the choice of the better distribution of light rays in space as well as in energy densities since many parameters are available to modify it.

Naturally, the input fiber is not necessarily a single-mode fiber. It could also be a multimode fiber. Furthermore, the system also works in the other direction (without changing the values of the radii of curvature or the diameters or the adaptation space) to transmit light rays coming from a multimode fiber 9 to a single-mode fiber 5, or to another multimode fiber. Similarly, one of these fibers may be replaced by an optoelectronic device, especially an optoelectronic integrated circuit for transmission or reception.

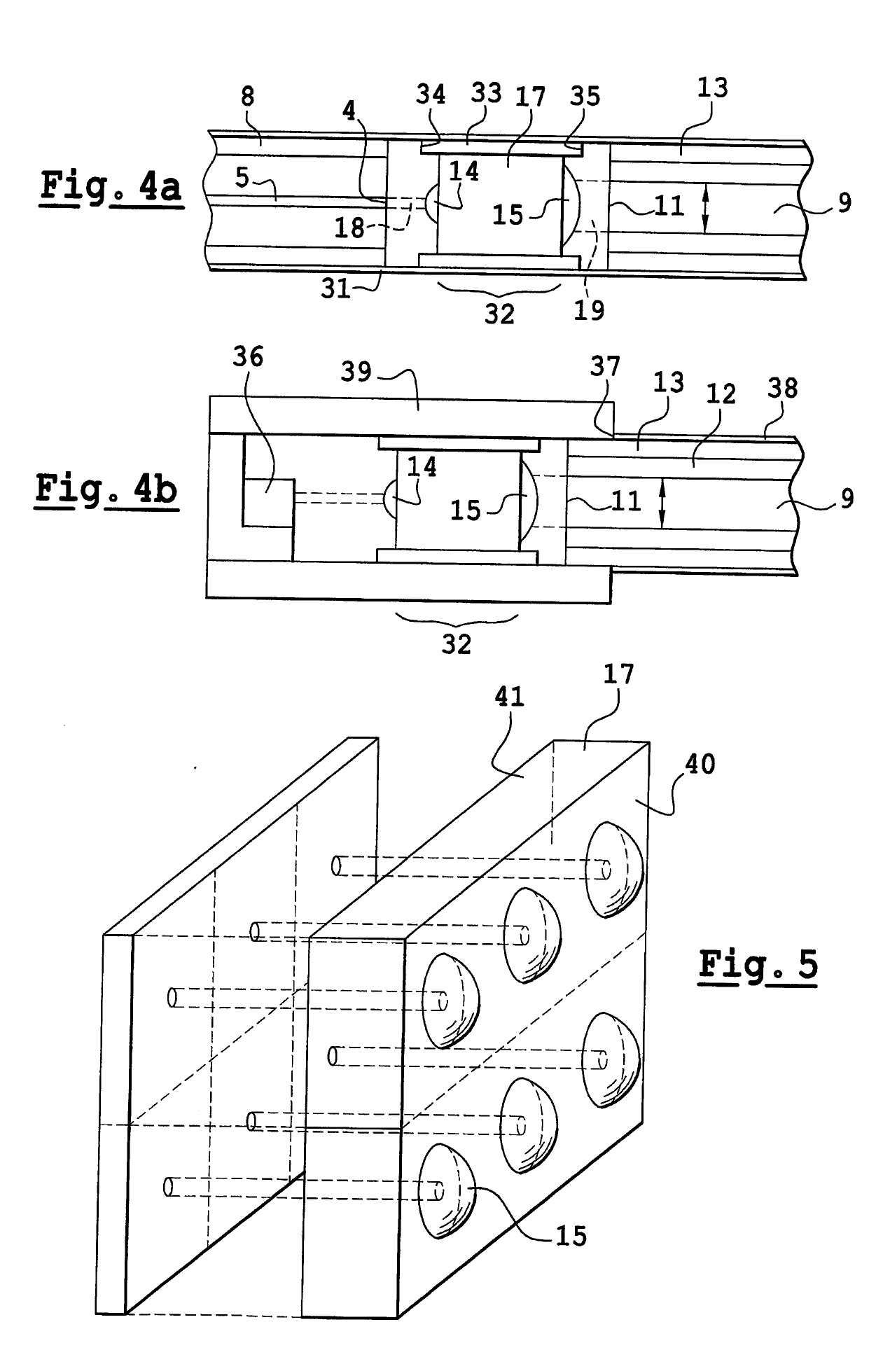

FIGS. 4a and 4b show an example of integration of the principle of the invention in a real connector. According to its principle, a real connector comprises a guide 31 which, in one example has a circular cylindrical shape, receiving the optical fibers 5 and 9 in a sliding movement. The ferrules 8 and 13, crimped at the position of the terminations 4 and 11, facilitate handling. The ferrules 8 and 13 fit precisely into the guide 31, on either side. A block 32 has been placed in the guide 31. This block 32 comprises an element of the plate 17 forming the adaptation space. The element of the plate 17 is surmounted on each side by a lens 14 and 15 respectively. The block 32 is fitted into a tube element 33. The tube 33 thus equipped is mounted in the guide 31, before the insertion of the two optical fibers 5 and 9. The end 34 and 35 respectively of the tube 32 form stops for the ferrules 8 and 13 during the insertion of the optical fibers 5 and 9. These stops 34 and 35 extend beyond the external plane of the lenses 14 and 15. The stops 34 and 35 enable the insertion of these optical fibers to be adjusted at a desired distance. In practice, the rays 18 and 19 are not parallel rays, especially because the terminations of the optical fibers, despite all the care taken in their manufacture are not capable of producing such output radiation. The beams 18 and 19 are therefore divergent. In this case, the presence of the stops 34 and 35 and the distancing that they impose give yet more degrees of freedom to set the adaptation of the transmission.

In FIG. 4b, the right-hand part is identical to the right-hand part of FIG. 4a: it shows the termination of a multimode fiber 9. Rather than allowing for an interconnection with a single-mode fiber, a transmitter or receiver optoelectronic circuit 36 is directly mounted in the connector of the other side of the adaptation device 32 of the invention relative to the termination 11 of the optical fiber 9. This approach makes it possible to do without the presence of a single-mode optical fiber section classically used for interconnection with an optoelectronic device 36. The optoelectronic device 36 is furthermore electrically connected, in a manner not shown, to a circuit for the processing and conversion of the light signals into electronic signals and vice versa. The presence of the stops 34 and 35 may be replaced in this case by the existence of a stop 37 present at the contact between a ring 38 crimped around the ferrule 13 of the fiber 9, and an edge of a package 39 containing the optoelectronic circuit 36. In this case, it is also possible to envisage an ability to shift the adaptation circuit 32 of the invention, or more precisely an ability to set this adaptation circuit 32 at a place chosen in advance.

The different settings are made either by simulation or by empirical tests. In this case, a very long transmission fiber 9 is used and, by means of an optoelectronic circuit 36 or a fiber 5, light signals are injected through the device 32. Modifications are then made in the nature of the device (the radii of curvature 22 and 23, the width 16 of the space 17), as well as in position by the length of the stops 34 and 35 of the device 32 relative to the terminations 4 and 11. An optimum setting is obtained empirically. It is then chosen to make the blocks 32 as well as the guide 31 or the packages 39 industrially, with the dimensions thus discovered.

At the practical level, since there are two types of multimode fibers, for a given interconnection device, with a guide 31, it is possible to provide for two blocks 32, blocks of a first type and blocks of a second type, and the user then has to choose between a block of one type and a block of another type depending on the nature of the multimode optical fibers that he must interconnect. If need be, the blocks concerned comprise information to simplify the positioning operation, and the user then only has to install a block corresponding to a type of optical fiber that he is using.

FIG. 5 shows an extension of the connector of the invention. Indeed, there are known ways in optoelectronic devices of connecting several optical fibers side by side in a device with several other fibers, or several other optoelectronic devices, also side by side. To this end, the plate 17 is larger than the one corresponding to a module of a block 32. On a first face 40, it comprises a first set of lenses such as 15 and, on a second face 41, opposite and parallel to the first face 40, it has a second set of lenses such as 14 (not shown). The distances between the lenses 15 on the face 40 are standardized and correspond to a standardized distance in a multiple optical ferrule having numerous optical terminations.

It can be noted that the plate 17, while being transparent in its totality, is not a waveguide for the light waves that go through it. These light waves undergo only classical optical conversion therein, the quality of the transmission being related to the mutual correspondence of the lenses 14 and 15. The manufacture of a device like that of FIG. 5 is therefore simple. It suffices to overmold several lenses (preferably at the same time), the mold comprising cavities at a distance from one another with spaces corresponding to the spaces made between the different lenses 15. If necessary, it is possible to manufacture the modules 32 in this way. After a comprehensive overmolding of several lenses 15, the plate 17 may be cut to selectively isolate each of the blocks concerned. Naturally, on one face 40 as well as on the other face 41 the focal distances of the different lenses made are not necessarily identical but may vary from one lens to an adjacent lens. In practice, the plate 16 has a thickness 16 of about 1 millimeter plus or minus 10%. Thus, an array of lenses is made.

1. Connector comprising ports to receive optical ferrules and to correspond to single-mode to multi-mode conversions and vice versa, comprising an input optical port and an output optical port, characterized in that it comprises a set of two lenses each with a flat face, interposed between the two optical ports and placed against a plate made of transparent material to enable an adaptation of transmission of the light rays in space and in energy density, the two lenses having respective diameters and radii of curvature that are different to form a fanning out of the beam of light rays, from narrow to wide or in the other direction, from one optical port to the other.

2. A connector according to claim 1, characterized in that a focal point of each of the lenses is located in the space constituted by the plate made of transparent material.

3. A connector according to claim 1, characterized in that the transparent plate forms a divergent-convergent optical device.

4. A connector according to claim 1, characterized in that the two lenses have different diameters and/or radii of curvature.

5. A connector according to claim 1, characterized in that the transparent plate has a length of about one millimeter.

6. A connector according to claim 1, characterized in that it is provided with two detachable sets of lenses, especially in order to correspond to two modes of conversion from a single-mode propagation to a multimode propagation or vice versa, this multimode propagation being capable of taking two types of propagation.

7. A connector according to claim 1, characterized in that the plate, made of a transparent material that is preferably glass, is overmolded by the lenses.

8. A connector according to claim 1, characterized in that the plate made of a transparent material that is preferably glass is overmolded by an array of lenses.

9. A connector according to claim 8, characterized in that lenses overmolded on a face of the plate are lenses different from each other.

10. A connector according to claim 7, characterized in that the lenses are made of resin overmolded on the plate.
